(19) United States
(12) Patent Application Publication
(10) Pub. No.: US 2005/0082314 A1
(43) Pub. Date: Apr. 21, 2005

(54) Spray actuator collar for spray canisters

(76) Inventors: Glenn E. Macierowski, Sparta, NJ (US); Eric J. Goleskie, Piscataway, NJ (US)

Correspondence Address: LITMAN LAW OFFICES, LTD., P.O. BOX 15035 CRYSTAL CITY STATION, ARLINGTON, VA, 22215, US

(21) Appl. No.: 10/688,896

(22) Filed: Oct. 21, 2003

(51) Int. Cl. B67B 5/00

(52) U.S. Cl. 222/153.11

(57) ABSTRACT

A spray actuator collar for spray canisters that includes a base portion with an inner diameter form fitted for compressively receiving the top of a spray canister. The spray actuator collar includes an L-shaped channel and a push button. The L-shaped channel includes an entry section and a nozzle. The spray actuator collar also includes a safety flap, a built-in hinge point for the safety flap, an aperture defined in a rear portion of the safety flap, and a squared off flat forward section. The L-shaped channel leads to the nozzle under the squared off forward section. The nozzle is configured to release fluid from the spray canister at a predetermined angle. The spray actuator collar is a one piece injection molded item.

### BACKGROUND OF THE INVENTION

1. Field of the Invention

The present invention generally relates to spray canisters. More particularly, the invention relates to a one piece actuator collar, and a safety flap for spray canisters.

2. Description of the Related Art

Law enforcement individuals, such as police officers, security personnel, or the like, commonly carry a number of items with them during their on duty rotations. One of the devices police officers often carry is a spray canister to spray a chemical irritant and offer them assistance during potentially threatening public encounters. Spray canisters are normally carried as a separate item from other items, resulting in time consumption during threatening encounters for an individual to readily secure and actuate such a spray canister. It would be desirable for law enforcement individuals to have access to a spray actuator collar for spray canisters configured in a manner that enables rapid actuation and minimal mental drain to assist in threatening encounters.

The related art is represented by the following references of interest.

U.S. Patent Application Publication No. 2002/0096539 A1, published on Jul. 25, 2002 for Alex Milian et al., describes a fluid dispenser device including a dispenser member with an actuator rod. The Milian et al. application does not suggest a spray actuator collar for spray canisters according to the claimed invention.

U.S. Patent Application Publication No. 2003/0089739 A1, published on May 15, 2003 for William T. O'Connor et al., describes a pressurized dispensing system for dispensing a multi-component product. The O'Connor et al. application does not suggest a spray actuator collar for spray canisters according to the claimed invention.

U.S. Pat. No. 3,162,329, issued on Dec. 22, 1964 to Joseph J. Gregory, describes a valve protecting cap for aerosol type containers. The Gregory patent does not suggest a spray actuator collar for spray canisters according to the claimed invention.

U.S. Pat. No. 3,484,023, issued on Dec. 16, 1969 to Philip Meshberg, describes means for dispensing material from a container having a valve for controlling the dispensing of the material under pressure from the container. The Meshberg '023 patent does not suggest a spray actuator collar for spray canisters according to the claimed invention.

U.S. Pat. No. 3,642,179, issued on Feb. 15, 1972 to Lewis A. Micallef, describes a self-restoring dispenser for the valve stem of a pressurized container that has an actuator that cooperates with a closure member for the dispensing orifice of the actuator. The Micallef patent does not suggest a spray actuator collar for spray canisters according to the claimed invention.

U.S. Pat. Nos. 3,933,278 and 4,166,554, issued on Jan. 20, 1976 and Sep. 4, 1979, respectively, to Victor F. Anderson, describe a child-safe container assembly having closure accessible through an elongated passageway. The Anderson patents do not suggest a spray actuator collar for spray canisters according to the claimed invention.

U.S. Pat. No. 4,353,483, issued on Oct. 12, 1982 to Harold T. Pehr, describes a one piece molded closure cap for a material dispensing container having a material dispensing valve and nozzle such as an aerosol can. The Pehr patent does not suggest a spray actuator collar for spray canisters according to the claimed invention.

U.S. Pat. No. 4,434,914, issued on Mar. 6, 1984 to Philip Meshberg, describes a directional applicator for a self-defense product. The Meshberg '914 patent does not suggest a spray actuator collar for spray canisters according to the claimed invention.

U.S. Pat. No. 4,582,228, issued on Apr. 15, 1986 to George B. Diamond et al., describes an irritant aerosol spray container adapted for use under varying limiting conditions. The Diamond et al. patent does not suggest a spray actuator collar for spray canisters according to the claimed invention.

U.S. Pat. No. 5,392,961, issued on Feb. 28, 1995 to Paul D. Starrett, describes a safety tab device coupled to an aerosol container by a connecting member. The Starrett patent does not suggest a spray actuator collar for spray canisters according to the claimed invention.

U.S. Pat. No. 5,649,645, issued on Jul. 22, 1997 to Scott W. Demarest et al., describes an overcap spray assembly and method of its manufacture. The Demarest et al. patent does not suggest a spray actuator collar for spray canisters according to the claimed invention.

U.S. Pat. No. 5,842,601, issued on Dec. 1, 1998 to James W. Pierpoint, describes a combination night stick and irritant dispenser. The Pierpoint patent does not suggest a spray actuator collar for spray canisters according to the claimed invention.

U.S. Pat. No. 6,126,044, issued on Oct. 3, 2000 to Jeremy P. Smith, describes a lockable spray actuator assembly. The Smith patent does not suggest a spray actuator collar for spray canisters according to the claimed invention.

U.S. Pat. No. 6,382,463 B2, issued on May 7, 2002 to Philip Meshberg, describes a spray dispenser with a nozzle closure. The Meshberg '463 patent does not suggest a spray actuator collar for spray canisters according to the claimed invention.

U.S. Pat. No. 6,386,726 B1, issued on May 14, 2002 to Glenn E. Macierowski et al., describes a hand-held personal defense/police baton. The Macierowski et al. patent does not suggest a spray actuator collar for spray canisters according to the claimed invention.

None of the above inventions and patents, taken either singly or in combination, is seen to describe the instant invention as claimed. Thus a spray actuator collar for spray canisters solving the aforementioned problems is desired.

### SUMMARY OF THE INVENTION

The present invention is a spray actuator collar for spray canisters. The spray actuator collar includes a base portion with an inner diameter form fitted for compressively receiving the top of a spray canister. The spray actuator collar includes an L-shaped channel and a push button. The L-shaped channel includes an entry section and a nozzle. The spray actuator collar also includes a safety flap, a built-in hinge point for the safety flap, an aperture defined in a rear portion of the safety flap, and a squared off flat forward section. The L-shaped channel leads to the nozzle under the squared off forward section. The nozzle is configured to release fluid from the spray canister at a predetermined angle. The spray actuator collar is a one piece injection molded item.

The safety flap of the spray actuator collar remains in the down position until a user flips up the safety flap about the built-in hinge point with their thumb/finger to access the push button on the spray actuator collar. If a user pulls their thumb/finger away from the push button and safety flap, the continued resistance on the safety flap will automatically close the safety flap and cover the push button to prevent accidental discharge of liquid from a spray canister interconnected with the spray actuator collar. The aperture of the safety flap is configured for use in conjunction with a canopy cover of a side handle.

A side handle which may contain therein a spray canister interconnected with the form fitted spray actuator collar may be attached to the side of a straight baton to configure the straight baton in the form of a side handle baton. However, other side handles may be configured for containing therein such a spray canister and the form fitted spray actuator collar. The side handle includes a gripping portion and a stepped top with a canopy cover. The spray canister and a connection device are contained within this particular side handle. The connection device is configured to interconnect the side handle with a straight baton, and is configured to carry a chemical eye irritant.

The spray actuator collar is attached to the top of the spray canister. The squared off forward section is configured to enable the spray actuator collar to be placed in the side handle in only one direction. The squared off forward section is also configured to hold the spray actuator collar and the canister in place while inside the side handle so a user can still administer offensive and defensive maneuvers with the side handle interconnected to a baton without having to worry about the spray canister popping out of the side handle.

The aperture of the safety flap is configured for use in conjunction with the canopy cover of the side handle. The canopy cover has a spring pin which engages the aperture on the safety flap when the canopy cover is in a closed position. When the spring pin engages the aperture of the safety flap, the user is able to push the canopy cover forward to access the safety flap and push button and then pull the canopy cover rearward. However, the user is unable to freely pull the canopy cover rearward until they press the spring pin up and release the canopy cover.

Accordingly, it is a principal aspect of the invention to a spray actuator collar for spray canisters, the spray actuator collar including a base portion with an inner diameter form fitted for compressively receiving a top of a spray canister, an L-shaped channel, a safety flap, a push button, a built-in hinge point, and a squared off forward section, wherein the spray actuator collar is a one piece injection molded item.

It is a further aspect of the invention to provide a spray actuator collar for spray canisters, the spray actuator collar including a base portion with an inner diameter form fitted for compressively receiving a top of a spray canister, an L-shaped channel, a safety flap, a push button, a built-in hinge point, and a squared off forward section, wherein the spray actuator collar is a one piece injection molded item, and the safety flap of the spray actuator collar remains in a down position until a user flips up the safety flap to access the push button on the spray actuator collar, and absence of force on the safety flap results in automatic closure of the safety flap.

It is another aspect of the invention to provide a spray actuator collar for spray canisters in combination with a side handle configured for being attached to a side of a baton, the side handle including a gripping portion and a stepped top with a canopy cover, the spray actuator collar including a base portion with an inner diameter form fitted for compressively receiving a top of a spray canister, an L-shaped channel, a safety flap, a push button, a built-in hinge point, and a squared off forward section, wherein the spray actuator collar is a one piece injection molded item, and the safety flap of the spray actuator collar remains in a down position until a user flips up the safety flap to access the push button on the spray actuator collar, and absence of force on the safety flap results in automatic closure of the safety flap

Still another aspect of the invention is to provide a spray actuator collar for spray canisters in combination with a side handle configured for being attached to a side of a baton, the side handle including a gripping portion and a stepped top with a canopy cover, the spray actuator collar including a base portion with an inner diameter form fitted for compressively receiving a top of a spray canister, an L-shaped channel, a safety flap, a push button, a built-in hinge point, and a squared off forward section, wherein the spray actuator collar is a one piece injection molded item, and the safety flap of the spray actuator collar remains in a down position until a user flips up the safety flap to access the push button on the spray actuator collar, and absence of force on the safety flap results in automatic closure of the safety flap, and wherein the L-shaped channel leads to a nozzle under the squared off forward section the squared off forward section being configured to enable the spray actuator collar to be placed in the side handle in only one direction, and being configured to hold the spray actuator collar and the spray canister in place while inside the side handle to preclude dislodgement of the spray canister from the side handle, and the nozzle being configured to release fluid from the spray canister at a predetermined angle

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1 is a side perspective view of a spray actuator collar for spray canisters according to the present invention.

FIG. 2 is a side cross sectional view of the spray actuator collar shown in FIG. 1.

FIG. 3 is a front view of the spray actuator collar shown in FIG. 1.

FIG. 4 is a rear view of the spray actuator collar shown in FIG. 1.

FIG. 5 is a front side view of the spray actuator collar shown in FIG. 1 with the nozzle facing toward the left.

FIG. 6 is a front side view of the spray actuator collar shown in FIG. 1 with the nozzle facing toward the right.

FIG. 7A is a cross sectional side view of the spray actuator collar shown in FIG. 1 in a closed position.

FIG. 7B is a cross sectional side view of the spray actuator collar shown in FIG. 1 in an open position.

FIG. 7C is a cross sectional side view of the spray actuator collar shown in FIG. 1 in an open and active position.

FIG. 8 is a top plan view of the spray actuator collar as shown in FIG. 1.

FIG. 9 is a sectional view of another embodiment of the invention.

Similar reference characters denote corresponding features consistently throughout the attached drawings.

### DETAILED DESCRIPTION OF THE PREFERRED EMBODIMENTS

The present invention is a spray actuator collar for spray canisters. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

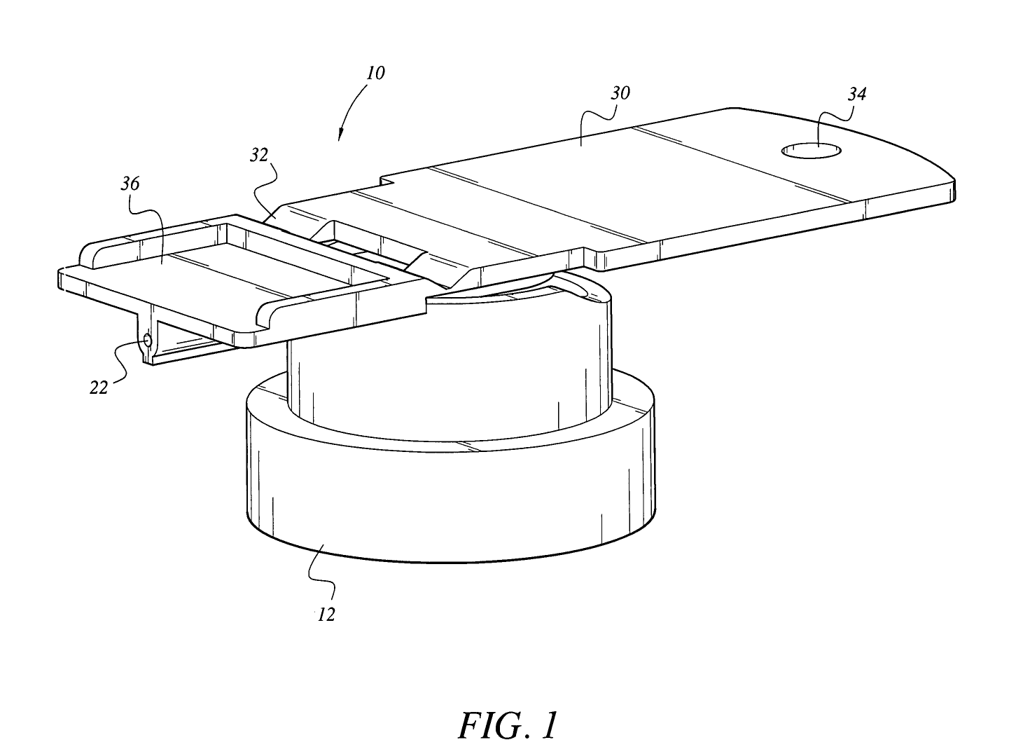

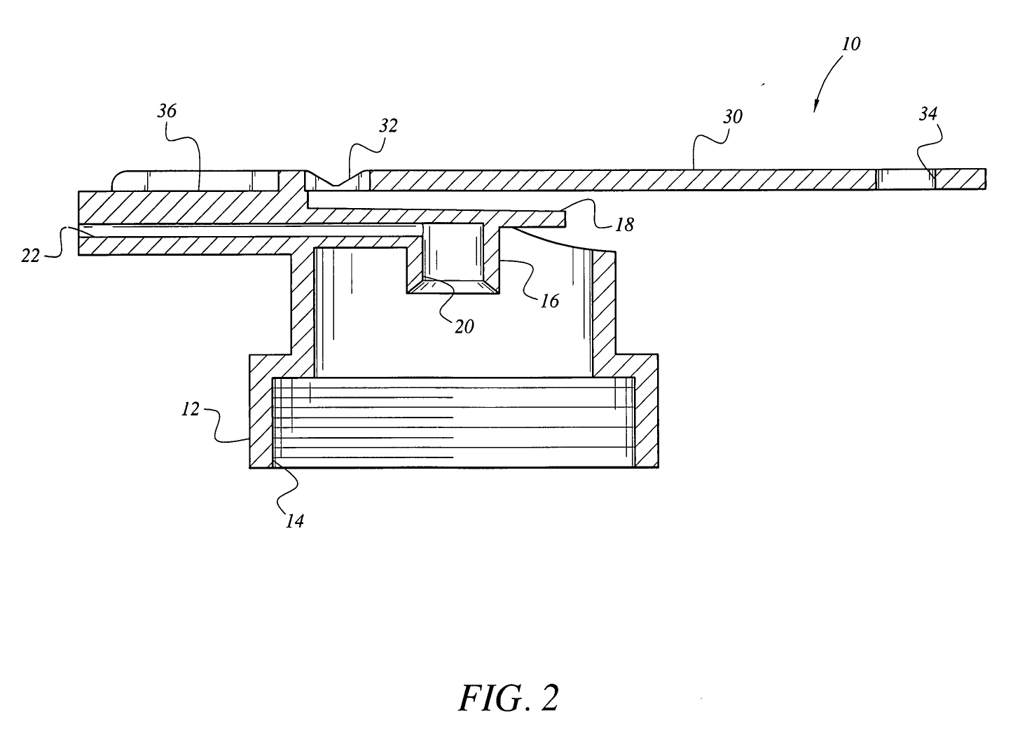

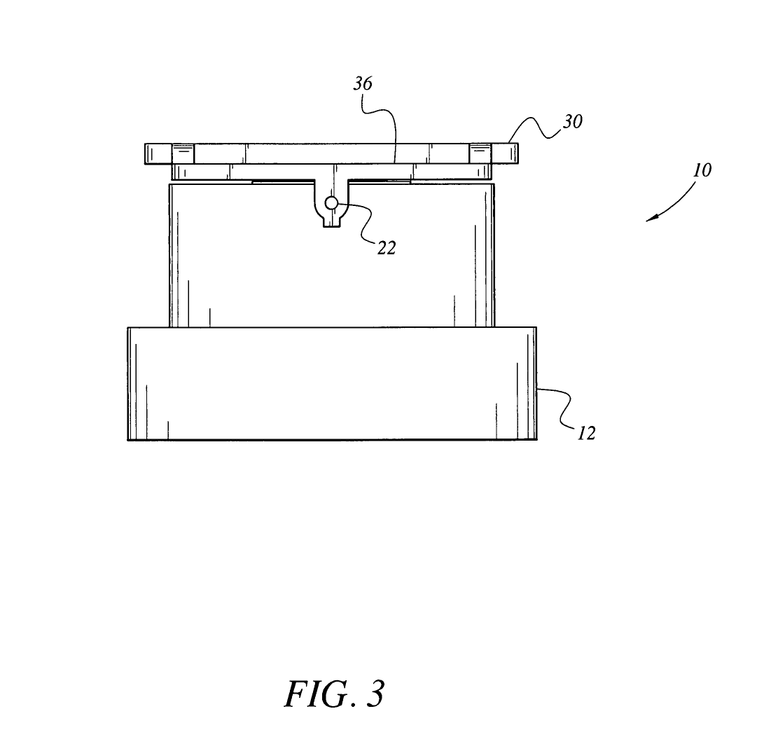

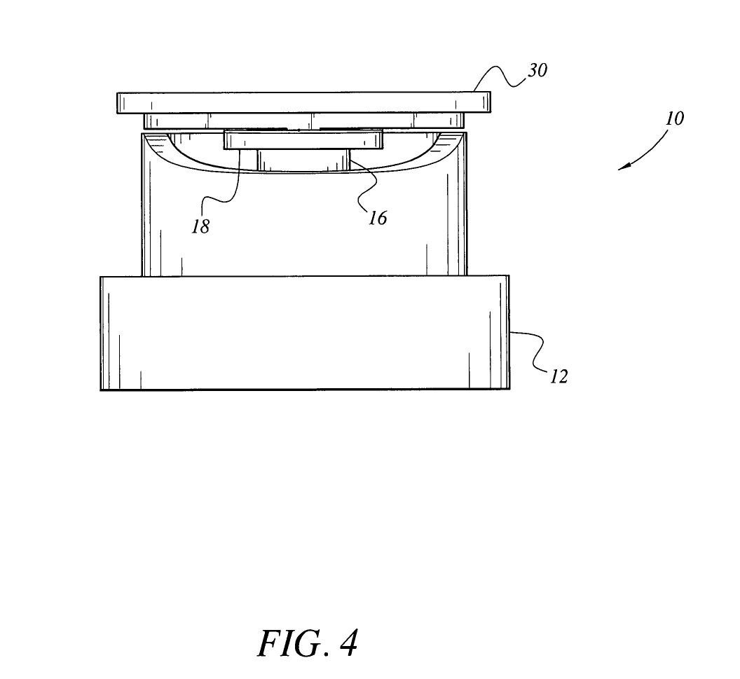

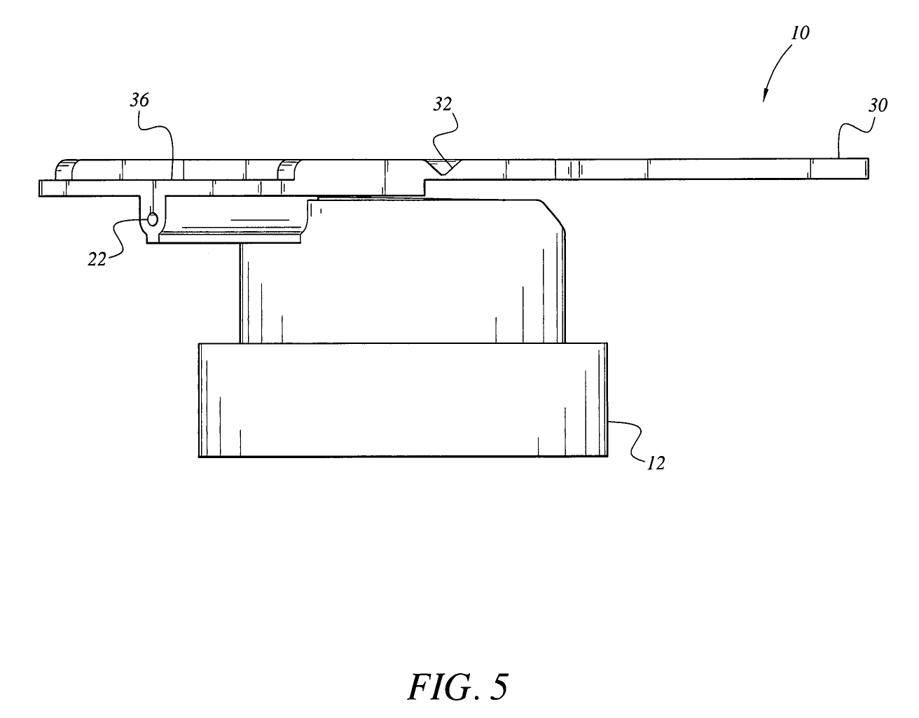

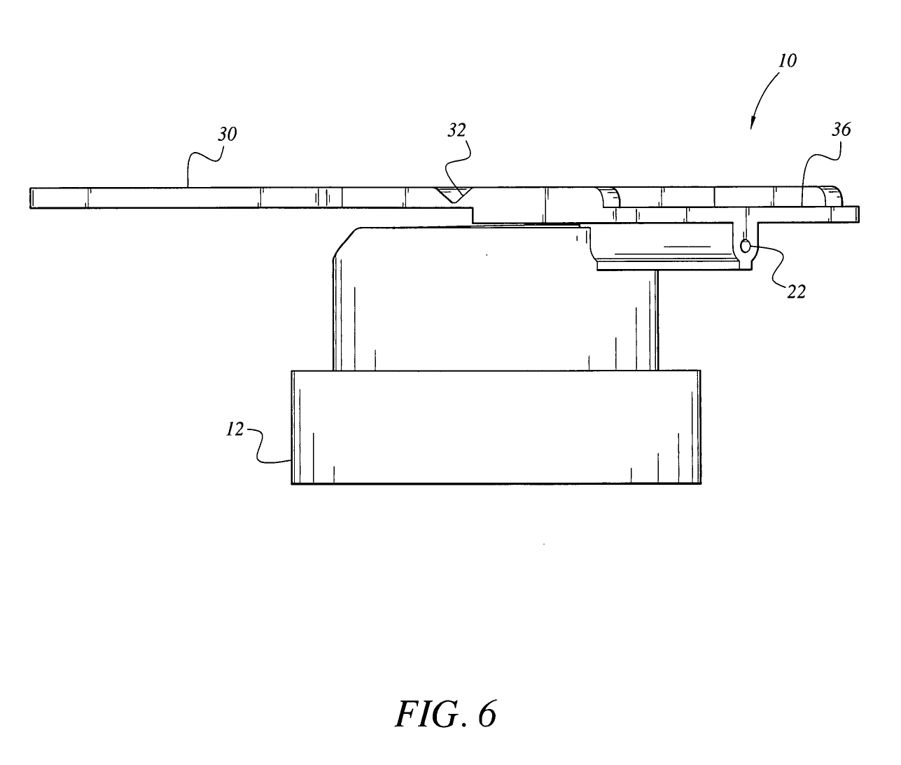

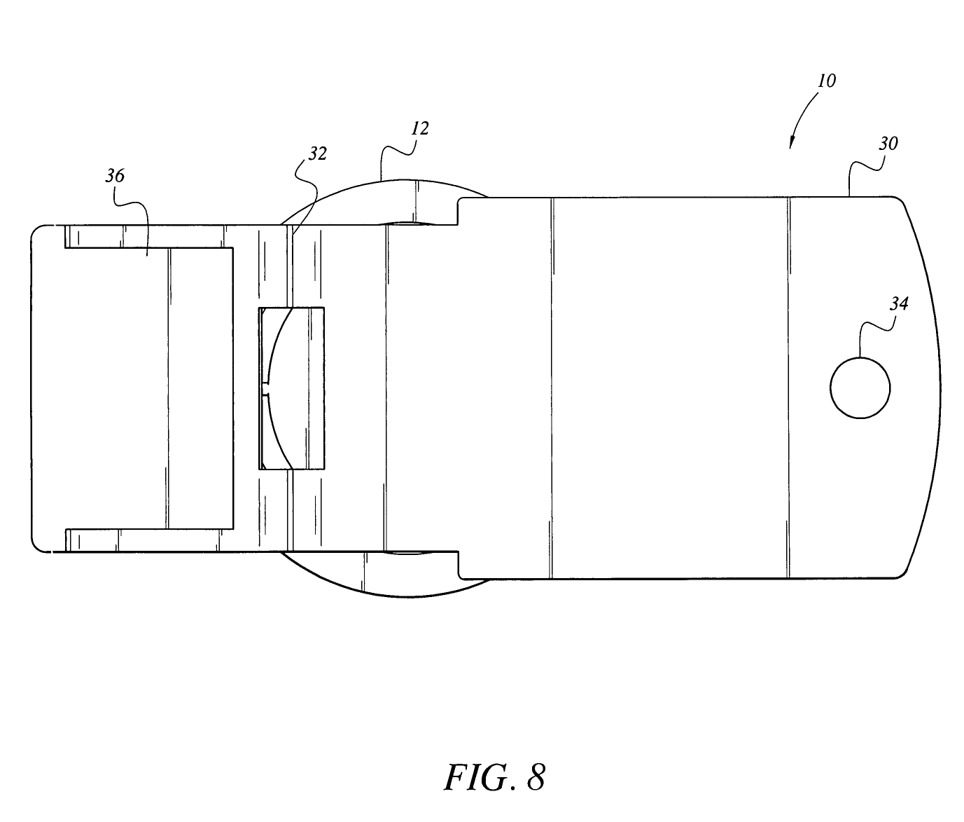

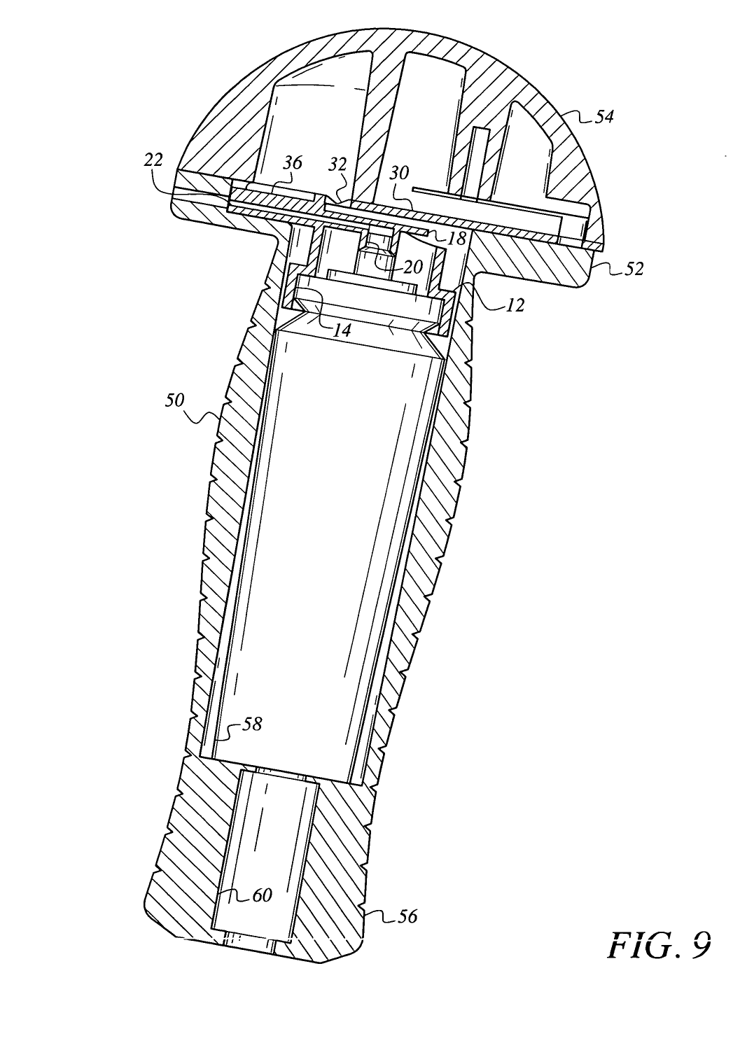

Referring to the drawings, FIGS. 1-8 illustrate a spray actuator collar 10 according to the invention. The spray actuator collar 10 includes a base portion 12 with an inner diameter 14 form fitted for compressively receiving the top of a spray canister 58 (see FIG. 9). Preferably, the inner diameter 14 of the spray actuator collar 10 is form fitted for receiving the top of a standard ¾ ounce canister. However, the inner diameter 14 of the spray actuator collar 10 may be form fitted for receiving the top of any type of spray canister.

The spray actuator collar 10 includes an L-shaped channel 16 and a push button 18. The L-shaped channel 16 includes an entry section 20 and a nozzle 22. The spray actuator collar 10 also includes a safety flap 30, a built-in hinge point 32 for the safety flap 30, an aperture 34 defined in a rear portion of the safety flap 30, and a squared off flat forward section 36. The L-shaped channel 16 leads to the nozzle 22 under the squared off forward section 36. The nozzle 22 is configured to release fluid from the spray canister at a predetermined angle. The spray actuator collar 10 is a one piece injection molded item, and may be injection molded from durable material, such as polycarbonate material, polypropylene material, etc.

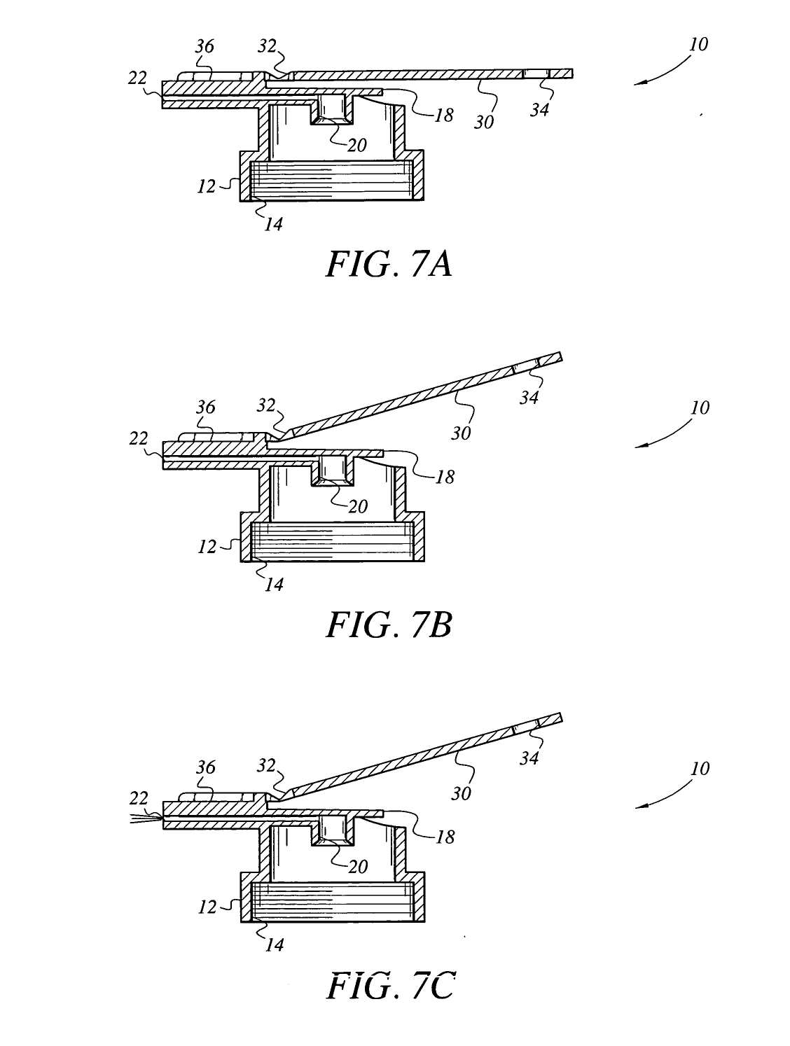

Referring to FIGS. 7A-7C, the safety flap 30 of the spray actuator collar 10 remains in the down position until a user flips up the safety flap 30 about the built-in hinge point 32 with their thumb/finger to access the push button 18 on the spray actuator collar 10. If a user pulls their thumb/finger away from the push button 18 and safety flap 30, the continued resistance on the safety flap 30 will automatically close the safety flap 30 and cover the push button 18 to prevent accidental discharge of liquid from a spray canister interconnected with the spray actuator collar 10. The aperture 34 of the safety flap 30 is configured for use in conjunction with a canopy cover 54 of a side handle to be described later.

FIG. 9 illustrates an example of a side handle which may contain therein a spray canister 58 interconnected with the form fitted spray actuator collar 10 previously described. The side handle may be attached to the side of a straight baton (not shown) to configure the straight baton in the form of a side handle baton. However, other side handles may be configured for containing therein such a spray canister and the form fitted spray actuator collar 10. The side handle includes a gripping portion 50 and a stepped top 52 with a canopy cover 54. The spray canister 10 and a connection device 60 are contained within this particular side handle. As stated before, the spray canister 58 is preferably a standard ¾ ounce canister, but may be any type of spray canister. The connection device 60 is configured to interconnect the side handle with a straight baton (not shown), and is configured to carry a chemical eye irritant, such as Mace® or the like.

The spray actuator collar 10 is attached to the top of the spray canister 58. The spray actuator collar 10 is a one piece injection molded item, and may be injection molded from durable material, such as polycarbonate material, etc. The squared off forward section 36 is configured to enable the spray actuator collar to be placed in the side handle in only one direction. The squared off forward section 36 is also configured to hold the spray actuator collar 10 and the canister 58 in place while inside the side handle so a user can still administer offensive and defensive maneuvers with the side handle interconnected to a baton without having to worry about the spray canister 58 popping out of the side handle.

The aperture 34 of the safety flap 30 is configured for use in conjunction with the canopy cover 54 of the side handle. The canopy cover 54 has a spring pin which engages the aperture 34 on the safety flap 30 when the canopy cover is in a closed position. When the spring pin engages the aperture 34 of the safety flap 30, the user is able to push the canopy cover 54 forward to access the safety flap 30 and push button 18 and then pull the canopy cover 54 rearward. However, the user is unable to freely pull the canopy cover 54 rearward until they press the spring pin up and release the canopy cover 54.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

1. A spray actuator collar for spray canisters, said spray actuator collar comprising:
a base portion with an inner diameter form fitted for compressively receiving a top of a spray canister;
an L-shaped channel;
a safety flap;
a push button;
a built-in hinge point; and
a squared off forward section,
wherein the spray actuator collar is a one piece injection molded item.

2. The spray actuator collar according to claim 1, wherein the spray actuator collar is injection molded from durable material.

3. The spray actuator collar according to claim 2, wherein the durable material is polycarbonate material.

4. The spray actuator collar according to claim 2, wherein the durable material is polypropylene material.

5. The spray actuator collar according to claim 1, wherein the safety flap of the spray actuator collar remains in a down position until a user flips up the safety flap to access the push button on the spray actuator collar, and absence of force on the safety flap results in automatic closure of the safety flap.

6. The spray actuator collar according to claim 5, wherein the L-shaped channel leads to a nozzle under the squared off forward section, the squared off forward section being configured to enable the spray actuator collar to be placed in a side handle in only one direction, and being configured to hold the spray actuator collar and a spray canister in place while inside the side handle to preclude dislodgement of the spray canister from the side handle, and the nozzle being configured to release fluid from the spray canister at a predetermined angle.

7. The spray actuator collar according to claim 5, in combination with a side handle configured for being attached to a side of a baton, the side handle including a gripping portion and a stepped top with a canopy cover.

8. The spray actuator collar according to claim 7, further comprising a spray canister and a connection device contained within the side handle, the spray canister being configured to carry a chemical eye irritant, and the connection device being configured to interconnect the side handle with the straight baton.

9. The spray actuator collar according to claim 7, wherein the L-shaped channel leads to a nozzle under the squared off forward section, the squared off forward section being configured to enable the spray actuator collar to be placed in the side handle in only one direction, and being configured to hold the spray actuator collar and the spray canister in place while inside the side handle to preclude dislodgement of the spray canister from the side handle, and the nozzle being configured to release fluid from the spray canister at a predetermined angle.
